(19) United States
(12) Patent Application Publication
(10) Pub. No.: US 2008/0301322 A1
(43) Pub. Date: Dec. 4, 2008

(54) NETWORK CONTROLLER, INFORMATION PROCESSING APPARATUS AND WAKE-UP CONTROL METHOD

(75) Inventor: Katsunori HORIBE, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/130,837

(22) Filed: May 30, 2008

(30) Foreign Application Priority Data
May 30, 2007 (JP) 2007-143668

(51) Int. Cl. G06F 15/16

(52) U.S. Cl. 709/245

(57) ABSTRACT

According to one embodiment, a network controller includes a data register which stores first data indicative of a data pattern of an address resolution protocol request packet including a network address of an information processing apparatus, and second data indicative of a data pattern of a wake-up packet for waking up the information processing apparatus, a comparison unit configured to compare a data pattern of an incoming packet with the first data and the second data, while the information processing apparatus is in a sleep state, a transmission unit configured to send, if the data pattern of the incoming packet agrees with the first data, the address resolution protocol reply packet to the network, and a wake-up signal output unit configured to output, if the data pattern of the incoming packet agrees with the second data, a wake-up signal for instructing wake-up to the information processing apparatus.

### CROSS-REFERENCE TO RELATED APPLICATIONS

This application is based upon and claims the benefit of priority from Japanese Patent Application No. 2007-143668, filed May 30, 2007, the entire contents of which are incorporated herein by reference.

### BACKGROUND

1. Field

One embodiment of the invention relates to a network controller having a function of waking up an information processing apparatus such as a personal computer, and an information processing apparatus including the network controller.

2. Description of the Related Art

In general, Wake on Lan (WOL) is known as a technique for remotely waking up an information processing apparatus, such as a personal computer, from outside.

The Wake on Lan (WOL) is a technique in which a wake-up packet including a specific data pattern is sent to the information processing apparatus via a LAN, thereby waking up the information processing apparatus.

While the information processing apparatus is in a sleep state, a network controller within the information processing apparatus monitors an incoming packet which comes in via the LAN, and determines whether the incoming packet is a wake-up packet including a specific data pattern or not. If the incoming packet is the wave-up packet, the network controller wakes up the information processing apparatus.

Normally, in a network such as a TCP/IP network, the network is divided into a plurality of subnets by a router. Thus, in order to wake up a node (A), which is connected to a subnet (A), from a node (B) which is connected to another subnet (B), it is necessary to transfer a wake-up packet from the subnet (B) to the node (A) via the router which connects the subnet (A) and subnet (B).

In this case, it is possible that the wake-up packet fails to be normally transferred to the node (A).

Specifically, in the case where a physical address (MAC address) corresponding to a network address (IP address) in a packet, which is received by the router, is not present in a database of the router, the router broadcasts an address resolution protocol request packet (ARP request packet) over the network, thereby to search for the physical address (MAC address) of the node that is designated by the received packet.

However, since the node (A) is in the sleep state, the node (A) cannot reply to the ARP request packet. Consequently, the router cannot recognize the physical address (MAC address) of the node (A), and cannot send to the node (A) the wake-up packet that is received from the node (B). Thus, wake-up of the node (A) fails.

As a solution to this problem, Jpn. Pat. Appln. KOKAI Publication No. 2006-86703 discloses an access management device having a function of sending an activation request packet for activating a terminal to the terminal, in response to a predetermined packet which is received from an external network. The access management device is connected to the terminal via a LAN, and includes a database in which TCP or UDP port numbers are associated with MAC addresses. Upon receiving a packet from the external network, the access management device detects, from the database, a MAC address corresponding to a destination port number of the received packet. The access management device generates an activation request packet for activating the terminal which has the detected MAC address, and outputs the activation request packet to the LAN.

In the technique of Jpn. Pat. Appln. KOKAI Publication No. 2006-86703, however, it is necessary to provide a dedicated access management device on the same LAN as the terminal that is to be activated, leading to an increase in cost.

It is thus necessary to realize a novel function which can easily realize remote wake-up, without providing a dedicated device such as an access management device.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing a network configuration in which an information processing apparatus including a network controller according to an embodiment of the present invention is connected;

FIG. 2 is an exemplary block diagram showing a system configuration of the information processing apparatus including the network controller according to the embodiment;

FIG. 3 is an exemplary block diagram showing a structure of the network controller according to the embodiment;

FIG. 4 is an exemplary diagram showing a structure of a data table register which is provided in the network controller according to the embodiment;

FIG. 5 is an exemplary diagram showing a structure of a mask register which is provided in the network controller according to the embodiment;

FIG. 6 is an exemplary diagram showing a structure of a transmission data register which is provided in the network controller according to the embodiment;

FIG. 7 is an exemplary diagram showing a data structure of an ARP request packet which is sent to the network controller according to the embodiment;

FIG. 8 is an exemplary diagram showing a data structure of an ARP reply packet which is sent from the network controller according to the embodiment;

FIG. 9 is an exemplary flow chart illustrating the procedure of a process which is executed by a CPU before the network controller according to the embodiment is set in a sleep mode (WOL mode);

FIG. 10 is a flow chart illustrating the procedure of a process which is executed by the network controller according to the embodiment while the network controller is in the sleep mode (WOL mode);

FIG. 11 is an exemplary diagram showing the procedure of a series of processes which are executed in order to remotely wake up the information processing apparatus including the network controller according to the embodiment;

FIG. 12 shows a wake-up packet which is sent from a terminal to a router in the network system shown in FIG. 1; and

FIG. 13 shows a wake-up packet which is sent from the router to the network controller according to the embodiment in the network system shown in FIG. 1.

### DETAILED DESCRIPTION

Various embodiments according to the invention will be described hereinafter with reference to the accompanying drawings. In general, according to one embodiment of the invention, there is provided a network controller which is provided in an information processing apparatus and executes communication with a network, including: a data register which stores first data indicative of a data pattern of an address resolution protocol request packet including a network address of the information processing apparatus, and second data indicative of a data pattern of a wake-up packet for waking up the information processing apparatus; a transmission data register which stores transmission data indicative of a data pattern of an address resolution protocol reply packet including a physical address of the information processing apparatus; a comparison unit configured to compare a data pattern of an incoming packet, which comes in via the network, with the first data and the second data, while the information processing apparatus is in a sleep state; a transmission unit configured to send, if the data pattern of the incoming packet agrees with the first data, the address resolution protocol reply packet to the network in accordance with the transmission data stored in the transmission data register; and a wake-up signal output unit configured to output, if the data pattern of the incoming packet agrees with the second data, a wake-up signal for instructing wake-up to the information processing apparatus.

To begin with, referring to FIG. 1, a description is given of an example of the network configuration in which an information processing apparatus including a network controller according to the embodiment is connected.

The network shown in FIG. 1 is a network such as a TCP/IP network. This network is divided into, for example, two subnets (also called “segments”) by a router 101. The router 101 is connected between two subnets A and B. Communication between nodes, which are present in the network shown in FIG. 1, is executed by using a packet including a destination address (destination MAC address) and a source address (source MAC address). Such a packet is known as, e.g. an Ethernet™ frame or an IEEE 802.3 frame.

In the subnet A, the information processing apparatus including the network controller according to the embodiment is connected as a node. This information processing apparatus is realized, for example, as a personal computer (PC) 100. In the subnet B, a PC 102, which is another terminal, is connected as a node.

In the present embodiment, an IP address (network address) which is assigned to the PC 100 is 0.0.0.2, and a MAC address (physical address) which is assigned to the PC 100 is 00-00-00-00-00-02. In fact, the MAC address 00-00-00-00-00-02 is the MAC address of the network controller that is provided in the PC 100.

The router 101 has two IP addresses corresponding to the subnets A and B, and two MAC addresses corresponding to the subnets A and B. The subnet A side IP address of the router 101 is 0.0.0.1, and the subnet A side MAC address of the router 101 is 00-00-00-00-00-01. The subnet B side IP address of the router 101 is 0.0.1.1, and the subnet B side MAC address of the router 101 is 00-00-00-00-01-01.

The IP address of the PC 102 is 0.0.1.2, and the MAC address of the PC 102 is 00-00-00-00-01-02.

The network controller provided in the PC 100 supports a Wake on Lan (WOL) function. Specifically, the network controller has a function of waking up the PC 100 when the network controller has received a wake-up packet for waking up the PC 100, which has a specific data pattern, via a LAN in the subnet A, while the PC 100 is in the sleep state.

Further, this network controller is so configured as to be able to reply to an address resolution protocol request packet (ARP request packet) including the IP address of the PC 100 while the PC 100 is in the sleep state, so that the network controller may easily remotely wake up the PC 100 in the subnet A from the PC 102 in the subnet B without using a special device.

Specifically, the network controller has a function of automatically sending an address resolution protocol reply packet (ARP reply packet), which includes the MAC address (00-00-00-00-00-02) of the PC 100, to the LAN in the subnet A, when the network controller has received an ARP request packet including the IP address of the PC 100 via the LAN in the subnet A while the PC 100 is in the sleep state.

In order to realize these functions, the network controller in the PC 100 includes a data table register (also referred to simply as “data register”) and a transmission data register. The data table register stores first data which is indicative of a data pattern of the ARP request packet including the IP address of the PC 100 as a to-be-checked address, and second data which is indicative of a data pattern of the wake-up packet for waking up the PC 100. The transmission data register stores transmission data which is indicative of a data pattern of the address resolution protocol reply packet (ARP reply packet) including the MAC address of the PC 100. The ARP reply packet is a packet which is to be returned in reply to the reception of the ARP request packet, and is used in order to inform the origin of inquiry of the MAC address of the node that is designated by the IP address included in the ARP request packet.

While the PC 100 is in the sleep state, the network controller compares each of incoming packets, which come in via the LAN in the subnet A, with the first and second data.

If the incoming packet agrees with the first data, the network controller sends the transmission data, which is stored in the transmission data register, to the LAN in the subnet A as the ARP reply packet. If the incoming packet agrees with the second data, the network controller outputs a wake-up signal for instructing wake-up to the PC 100.

By the above-described structure, the network controller can reply to the ARP request packet from the router 101 even while the PC 100 is in the sleep state. Accordingly, since the router 101 can recognize the MAC address of the PC 100, the router 101 can correctly send the wake-up packet, which is received from the PC 102 and is destinated to the PC 100, to the MAC address of the PC 100. Therefore, the wake-up packet from the PC 102 in the subnet B can be sent to the PC 100 in the subnet A via the router 101 without providing a dedicated device, such as an access management device, in the same subnet A as the PC 100, and the PC 100 in the subnet A can be woken up via the router 101.

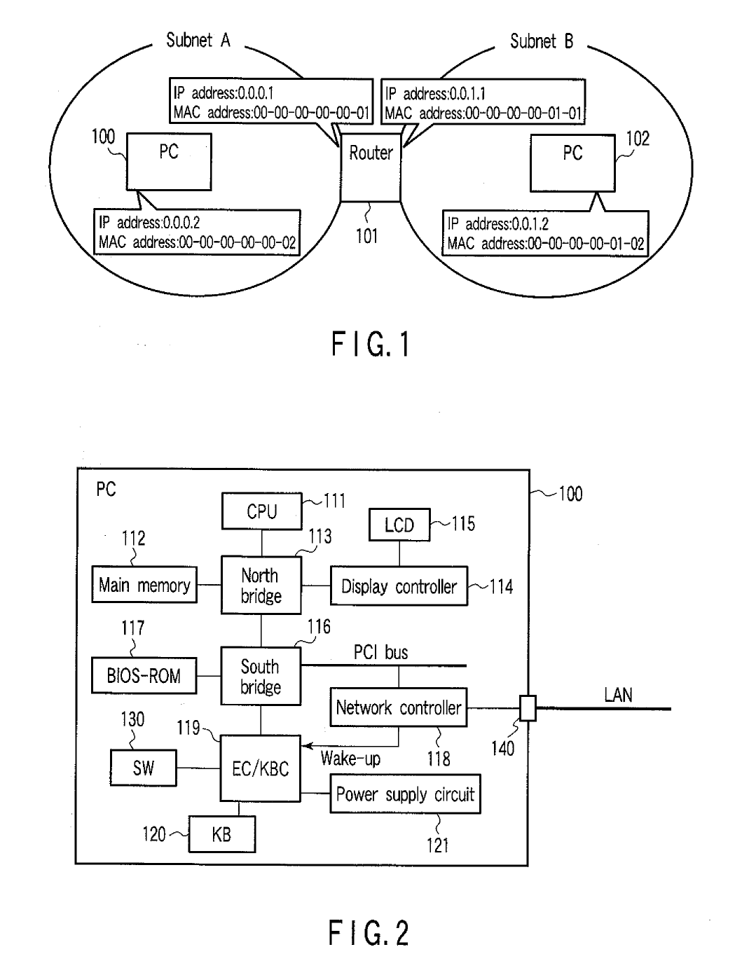

FIG. 2 shows an example of the system configuration of the PC 100.

The PC 100 comprises a CPU 111, a main memory 112, a north bridge 113, a display controller 114, a liquid crystal display (LCD) 115, a south bridge 116, a BIOS-ROM 117, a network controller 118, an embedded controller/keyboard controller IC (EC/KBC) 119, a keyboard 120, and a power supply circuit 121.

The CPU 111 is a processor that controls the operation of the respective components of the PC 100. The CPU 111 executes an operating system and various application programs. The CPU 111 also executes a BIOS that is stored in the BIOS-ROM 117. The BIOS is a program for hardware control.

The north bridge 113 is a bridge device that connects a local bus of the CPU 111 and the south bridge 116. In addition, the north bridge 113 has a function of executing communication with the display controller 114. Furthermore, the north bridge 113 includes a memory controller which controls the main memory 112.

The display controller 114 controls the LCD 115 that is used as a display monitor of the PC 100. The south bridge 116 controls devices on a PCI (Peripheral Component Interconnect) bus. The network controller 118 is connected to the PCI bus. The network controller 118 is a LAN controller (also called “network interface card NIC”) which executes communication with a LAN which is connected to a LAN connector 140. The network controller 118 supports the above-described WOL function, and outputs a wake-up signal (Wake-up) for instructing wake-up to the PC 100 if the network controller 118 receives a wake-up packet including a specific data pattern while the PC 100 is in the sleep state. The wake-up signal (Wake-up) is output to a power management device within the PC 100 (e.g. EC/KBC 119).

The EC/KBC 119 is a 1-chip microcomputer in which an embedded controller for power management and a keyboard controller for controlling the keyboard (KB) 120 are integrated. The EC/KBC 119 cooperates with the power supply circuit 121 and powers on/off the PC 100 in accordance with the operation of a power button switch (SW) 130 by the user. In addition, when the EC/KBC 119 has received the wake-up signal (Wake-up), the EC/KBC 119 cooperates with the BIOS and executes a process for restoring the state of the PC 100 from a sleep state to a normal working state. For example, S3 (memory suspend state) or S4 (hibernation state), which is stipulated in the ACPI specification, is usable as the sleep state of the PC 100. Needless to say, a state in which almost all devices, other than the devices necessary for executing the WOL function (network controller 118 and EC/KBC 119), are turned off, may be used as the sleep state of the PC 100.

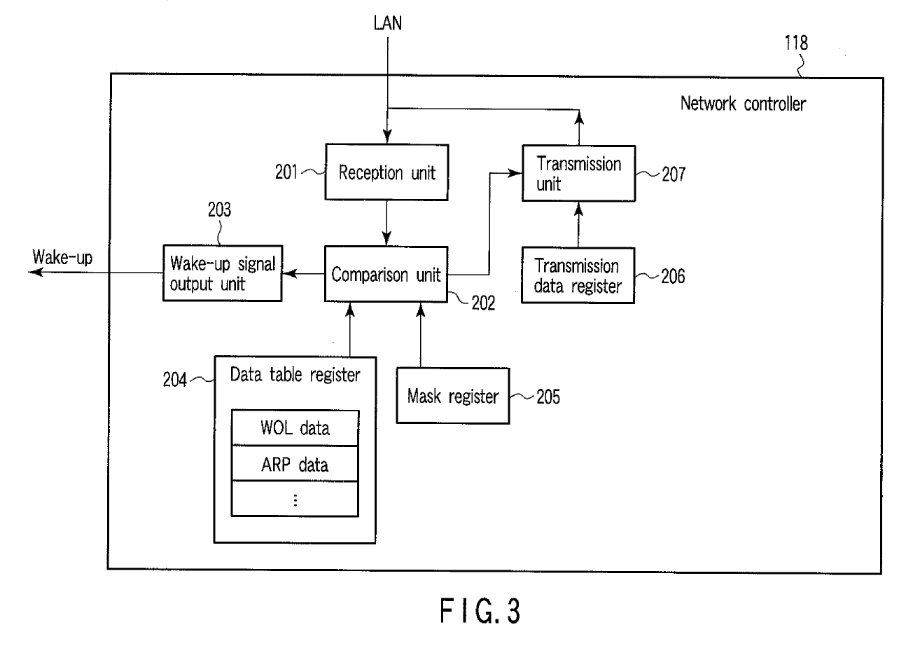

Next, referring to FIG. 3, the structure of the network controller 118 is described. FIG. 3 shows only functional units relating to the WOL function.

The network controller 118 includes a reception unit 201, a comparison unit 202, a wake-up signal output unit 203, a data table register 204, a mask register 205, a transmission data register 206, and a transmission unit 207. Even while the network controller 118 is in the sleep mode (also referred to as “WOL mode”), the reception unit 201, comparison unit 202, wake-up signal output unit 203, data table register 204, mask register 205, transmission data register 206 and transmission unit 207 are in the active state.

The reception unit 201 receives incoming packets which come in via the LAN (e.g. a packet including the MAC address of the PC 100 as a destination MAC address, a broadcast packet, etc.). The received packet is sent to the comparison unit 202. The comparison unit 202 compares the packet, which is received while the PC 100 is in the sleep state, that is, while the network controller 118 is in the sleep mode (WOL mode), and the data which is stored in the data table register 204.

The data table register 204 is a memory area for storing data which is to be compared with the packet that is received by the network controller 118. The data table register 204 stores WOL data and ARP data as data for comparison.

The ARP data is the above-described first data which is indicative of the data pattern of the ARP request packet for inquiring about the MAC address corresponding to the IP address of the PC 100. Specifically, the ARP data is indicative of the data pattern of the ARP request packet which is sent from the router 101 to the network controller 118. The ARP request packet includes, for instance, the IP address of the PC 100.

The WOL data is the above-described second data which is indicative of the data pattern of the wake-up packet for waking up the PC 100. The wake-up packet for waking up the PC 100 includes a specific data pattern (e.g. 6 bytes of FFh, and 16 duplications of the MAC address of the PC 100).

The mask data register 205 is a memory area for storing mask data which designates a data portion of the ARP data stored in the data table register 204, which is to be excluded from objects of matching. In the process of comparing the ARP data and the received packet, the comparison unit 202 determines whether the data portion of the ARP data, which is other than the data portion designated by the mask data, agrees with the data pattern of the received packet. In the case where the data portion of the ARP data, which is other than the data portion designated by the mask data, agrees with the data pattern of the received packet, the comparison unit 202 determines that the received packet is the ARP request packet. In the meantime, not only the mask data designating a data portion of the ARP data, which is to be excluded from objects of matching, but also mask data designating a data portion of the WOL data, which is to be excluded from objects of matching, may be set in the mask data register 205.

When the comparison unit 202 detects agreement between the received packet and the WOL data in the data table register 204, the wake-up signal output unit 203 outputs a wake-up signal to the EC/KBC 119.

The transmission data register 206 stores transmission data which is indicative of the data pattern of an ARP reply packet that is to be returned in reply to the reception of the ARP request packet. Specifically, the transmission data is indicative of the data pattern of the ARP reply packet which is to be sent to the router 101 in reply to the ARP request packet from the router 101. This data pattern includes, for instance, the MAC address of the PC 100.

When the comparison unit 202 detects agreement between the received packet and the ARP data in the data table register 204, the transmission unit 207 transmits the ARP reply packet to the LAN in accordance with the transmission data that is stored in the transmission data register 206. Specifically, since the transmission data stored in the transmission data register 206 has the same data structure as the ARP reply packet that is to be transmitted, the transmission unit 207 can correctly return the ARP reply packet including the MAC address of the PC 100 to the router 101 simply by sending the transmission data to the LAN.

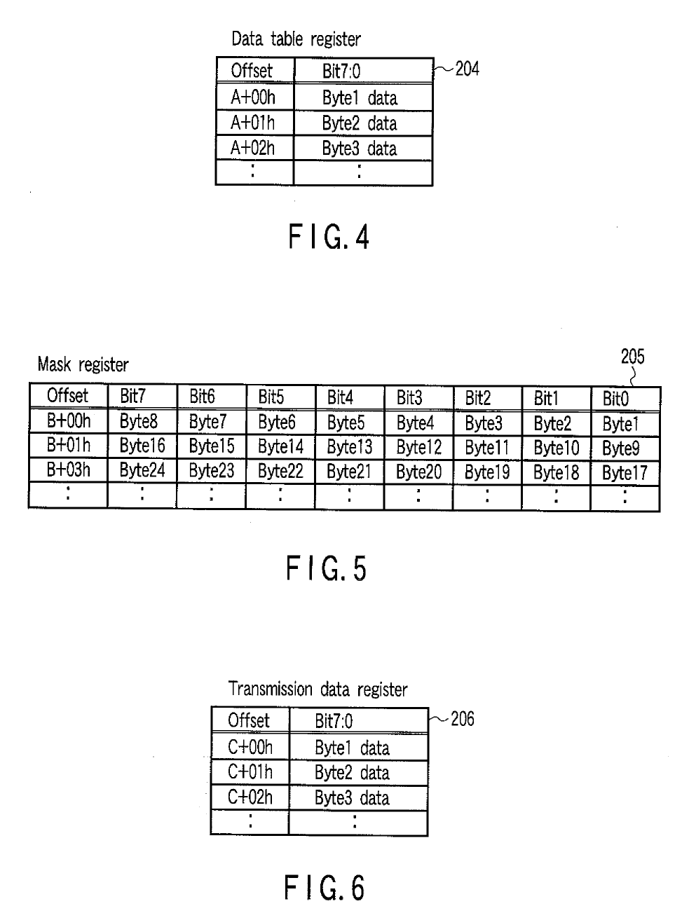

FIG. 4 shows an example of the structure of the data table register 204.

The data table register 204 is composed of, for example, a plurality of 8-bit registers having mutually different offset addresses. Each 8-bit register stores byte data. Before the PC 100 transitions to the sleep mode, that is, before the network controller 118 is set in the sleep mode (WOL mode), the CPU 111 sets WOL data and ARP data in the data table register 204.

FIG. 5 shows an example of the structure of the mask register 205.

The mask register 205, too, can be composed of, for example, a plurality of 8-bit registers having mutually different offset addresses. The mask register 205 stores mask data including a plurality of mask bits for designating whether or not to mask the respective plural byte data stored in the data table register 204 shown in FIG. 4. Mask bit “1” indicates that corresponding byte data in the data table register 204 is to be masked, and mask bit “0” indicates that corresponding byte data in the data table register 204 is not to be masked. For example, in the case where the mask bit of bit0 of offset=B+00h is “1”, Byte1 data in the data table register 204 in FIG. 4 is masked. For example, in the case where the mask bit of bit1 of offset=B+00h is “1”, Byte2 data in the data table register 204 in FIG. 4 is masked. The masked byte data is ignored in the process of comparison with the received packet. Before the PC 100 transitions to the sleep mode, that is, before the network controller 118 is set in the sleep mode (WOL mode), the CPU 111 sets mask data in the mask register 205.

FIG. 6 shows an example of the structure of the transmission data register 206.

The transmission data register 206, too, can be composed of, for example, a plurality of 8-bit registers having mutually different offset addresses. The transmission data register 206 is an area which stores transmission data (data sequence of the ARP reply packet) which is to be transmitted when the packet data, which is received by network controller 118, matches with the ARP data that is an object of comparison, which is designated by the ARP data in the data table register 204 and the mask data in the mask register 205. Before the PC 100 transitions to the sleep mode, that is, before the network controller 118 is set in the sleep mode (WOL mode), the CPU 111 sets transmission data in the transmission data register 206.

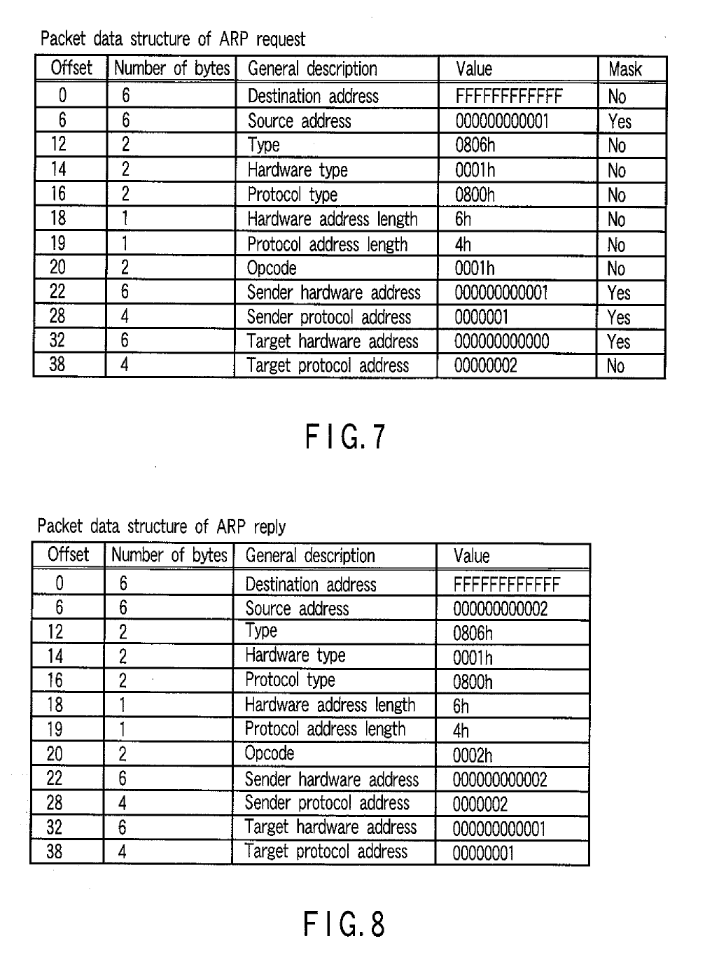

FIG. 7 shows an example of the data structure of the ARP request packet (ARP request).

The structure of the ARP request packet shown in FIG. 7 corresponds to the ARP request packet which is sent from the router 101 to the PC 100 via the LAN in the subnet A.

The ARP request packet is composed of a Destination address field, a Source address field, a Type field, a Hardware type field, a Protocol type field, a Hardware address length field, a Protocol address length field, an Opcode field, a Sender hardware address field, a Sender protocol address field, a Target hardware address field, and a Target protocol address field.

The Destination address field is a field which designates a destination MAC address of the present packet. In the ARP request packet, a broadcast MAC address (=FF-FF-FF-FF-FF-FF) is set in the Destination address field. The source address field is a field which designates a source MAC address of the present packet. In the ARP request packet, the MAC address (=00-00-00-00-00-01) of the router 101 is set in the Source address field.

The type field is a field which designates the type of the present packet. Type=0806h indicates that the type of the present packet is the ARP packet. The combination of the value (=0001h) of the Opcode field and the value (=0806h) of the Type field indicates that the present packet is an ARP request packet.

The value (=0001h) of the Hardware type field indicates Ethernet™. The Protocol type field is a field which designates an upper-layer protocol which is to be carried by the present packet, and Protocol type=0800h indicates IP.

The Sender hardware address field and the Sender protocol address field are fields which indicate the source MAC address and the source IP address of the present packet. In the ARP request packet, the MAC address (=00-00-00-00-00-01) of the router 101 is set in the Sender hardware address field, and the IP address (=00-00-00-01) of the router 101 is set in the Sender protocol address field.

The Target hardware address field and Target protocol address field are fields which indicate the destination MAC address and destination IP address of the present packet. In the ARP request packet, a null value (=00-00-00-00-00-00) is set in the Target hardware address field, and the IP address (=00-00-00-02) of the PC 100 is set in the Target protocol address field.

The CPU 111 sets values corresponding to the fields in FIG. 7 in the data table register 204 as ARP data. For example, the data corresponding to the Source address field, Sender hardware address field, Sender protocol address field and Target hardware address field can be masked. In FIG. 7, Mask=NO indicates that masking is not executed, and Mask=YES indicates that masking is executed. In the case where the data corresponding to the Source address field, Sender hardware address field, Sender protocol address field and Target hardware address field are masked, the network controller 118 can reply not only to the ARP request packet from the router 101, but also to ARP request packets from other nodes in the subnet A.

In addition, in the case where the Destination address, which is indicative of the broadcast MAC address, is set as ARP data, the reception unit 201 in FIG. 3 may receive all incoming packets, which come in via the LAN in the subnet A, since filtering using the Destination address is executed by the comparison unit 202.

FIG. 8 shows an example of the data structure of the ARP reply packet (ARP reply).

The ARP reply packet in FIG. 8 corresponds to the ARP reply packet which is sent from the PC 100 to the router 101 via the LAN in the subnet A.

The ARP reply packet, too, is composed of a Destination address field, a Source address field, a Type field, a Hardware type field, a Protocol type field, a Hardware address length field, a Protocol address length field, an Opcode field, a Sender hardware address field, a Sender protocol address field, a Target hardware address field, and a Target protocol address field.

The Destination address field is a field which designates a destination MAC address of the present packet. In the ARP reply packet, a broadcast MAC address (=FF-FF-FF-FF-FF-FF) is set in the Destination address field. The source address field is a field which designates a source MAC address of the present packet. In the ARP reply packet, the MAC address (=00-00-00-00-00-02) of the PC 100 is set in the Source address field.

The combination of the value (=0806h) of the Type field and the value (=0002h) of the opcode field indicates that the present packet is an ARP reply packet. The MAC address (=00-00-00-00-00-02) of the PC 100 is set in the Sender hardware address field, and the IP address (=00-00-00-02) of the PC 100 is set in the Sender protocol address field. The MAC address (=00-00-00-00-00-01) of the router 101 is set in the Target hardware address field, and the IP address (=00-00-00-01) of the router 101 is set in the Target protocol address field.

The CPU 111 sets values corresponding to the fields in FIG. 8 in the transmission data register 206 as transmission data.

The WOL data includes, for instance, the Destination address which is indicative of the broadcast MAC address or the MAC address of the PC 100, 6 bytes of FF and 16 duplications of the MAC address of the PC 100, as a data sequence which is to be compared with the data pattern of the wake-up packet.

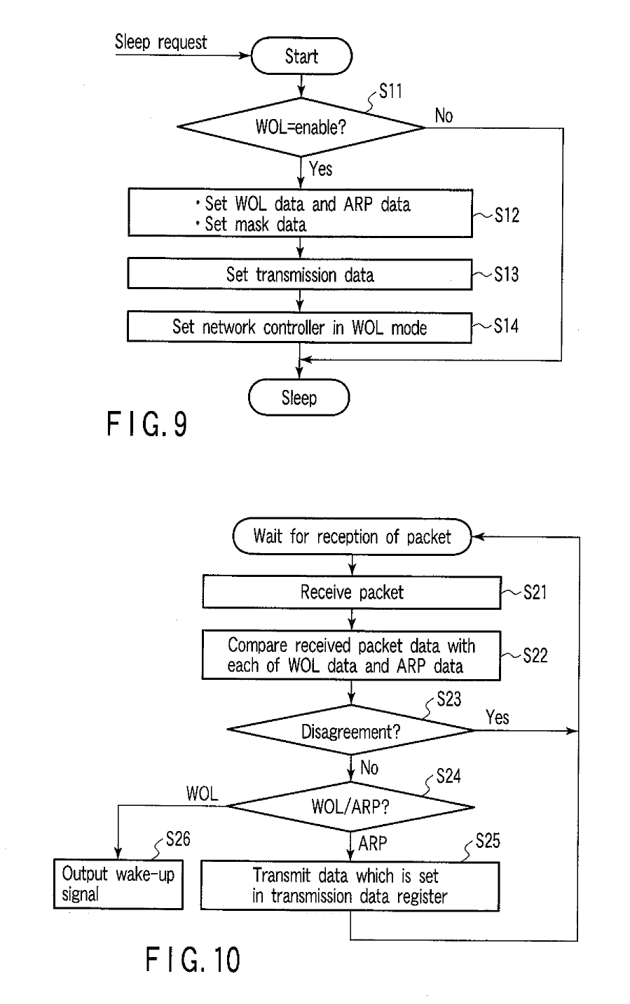

Next, referring to a flow chart of FIG. 9, a description is given of the procedure of a process which is executed by the CPU 111 when the PC 100 transitions to the sleep state.

The CPU 111 executes the following process, for example, under the control of a LAN driver which is software for controlling the network controller 118.

Specifically, when a sleep event (sleep request), such as an operation of the power button switch by the user, has occurred, the CPU 111 first determines whether the WOL function is enabled or not, by referring to setup information of the PC 100 (step S11). The setup information is information indicative of the operational environment of the PC 100 which is designated by the user. The user can designate in advance the enabling/disabling of the WOL function through, e.g. a BIOS setup screen.

If the WOL function is enabled (YES in step S11), the CPU 111 sets the WOL data and ARP data in the data table register 204, and sets the mask data in the mask register 205 (step S12). Then, the CPU 111 sets the transmission data in the transmission data register 206 (step S13). The CPU 111 executes a process of setting the network controller 118 in a sleep mode (WOL mode) for monitoring incoming of a wake-up packet (step S14). In step S14, the CPU 111 executes a process of setting a flag, which designates the sleep mode (WOL mode), in a predetermined register in the network controller 118, or a process of setting a predetermined pin (SLEEP pin), which is provided in the network controller 118, in an active state. By the process of step S14, the network controller 118 is switched from the normal working mode, in which transmission/reception of various packets is executed under the control of software, to the sleep mode (WOL mode). Power supply to the network controller 118 is maintained.

Thereafter, under the control of the BIOS, the CPU 111 sets the devices, other than the network controller 118, in the sleep state, thereby setting the PC 100 in the sleep state.

Next, referring to a flow chart of FIG. 10, a description is given of the operation of the network controller 118, which is executed during the sleep state of the PC 100.

In the sleep mode (WOL mode), the network controller 118 receives incoming packets addressed to the PC 100, which comes in via the LAN (e.g. a packet including the MAC address of the network controller 118 as a destination address, or a broadcast packet) (step S21). Needless to say, in the case where each of the WOL data and ARP data includes the MAC address of the network controller 118 or broadcast MAC address as a data portion that is to be compared with the destination address in the incoming packet, the network controller 118 may receive all incoming packets that come in via the LAN.

The network controller 118 compares the received packet with each of the WOL data and ARP data, and determines whether the received packet matches with the WOL data or ARP data (step S23).

If the received packet matches with neither the WOL data nor the ARP data (YES in step S23), the network controller 118 discards the received packet and waits for reception of the next packet.

If the received packet matches with the WOL data or the ARP data (NO in step S23), the network controller 118 determines whether the data, which matches with the received packet, is the WOL data or ARP data (step 24).

If the received packet matches with the ARP data, the network controller 118 outputs the ARP reply packet to the LAN in accordance with the transmission data that is stored in the transmission data register 206 (step S25). Thereafter, the network controller 118 waits for reception of the next packet.

If the received packet matches with the WOL data, the network controller 118 outputs the wake-up signal to the EC/KBC 119 in order to restore the PC 100 to the normal working mode (step S26). Responding to the wake-up signal, the PC 100 is woken up. Under the control of the BIOS, the CPU 111 restores the network controller 118 to the normal active mode.

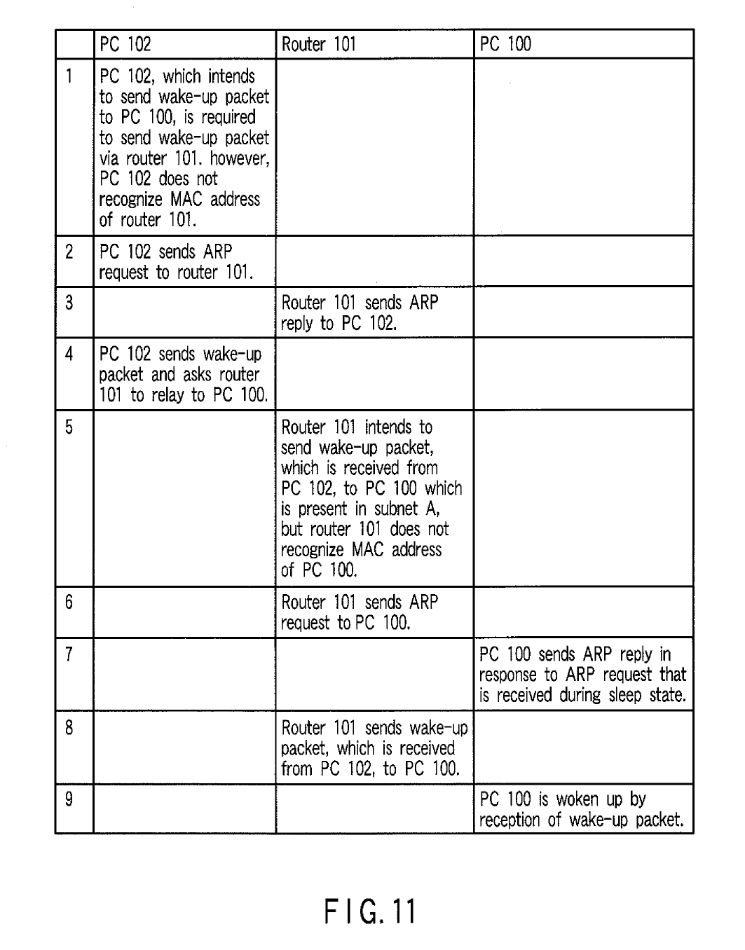

Next, referring to FIG. 11, a description is given of the procedure of a series of processes which are executed in the case where the PC 102 remotely wakes up the PC 101.

(1) Since the PC 100 and PC 102 are connected to mutually different subnets, the PC 102, which intends to send a wake-up packet to CPU 100, is required to send a wake-up packet for waking up the PC 100 to the router 101. However, the PC 102 does not recognize the MAC address of the router 101.

(2) Thus, the PC 102 sends to the LAN in the subnet B an ARP request packet for inquiring about the MAC address of the router 101. This ARP request packet includes the IP address of the router 101.

(3) The router 101, upon receiving the ARP request packet including its own IP address, sends an ARP reply packet including its own MAC address to the LAN in the subnet B. By receiving the ARP reply packet, the PC 102 can recognize the MAC address of the router 101.

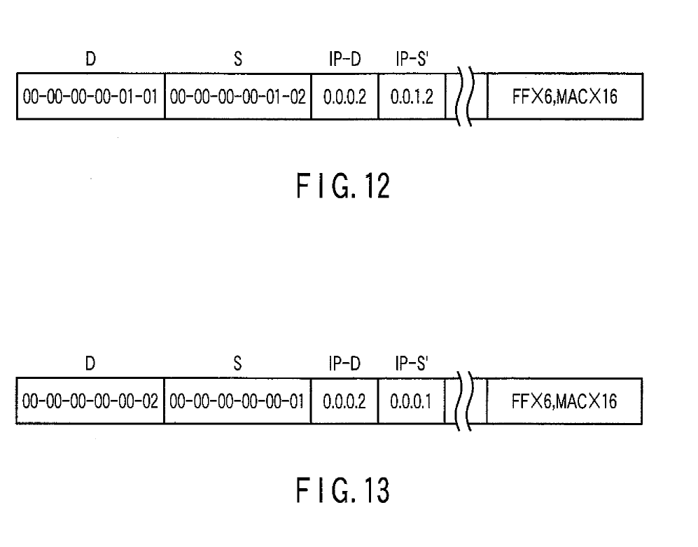

(4) The PC 102 sends to the router 101 a wake-up packet for waking up the PC 100. FIG. 12 shows an example of the data structure of the wake-up packet. In the wake-up packet, the value of the Destination address (D) indicates the subnet B side MAC address (00-00-00-00-01-01) of the router 101, and the value of the Source address (S) indicates the MAC address (00-00-00-00-01-02) of the PC 102. The value of the destination IP address (IP-D), which is set in the Target protocol address field, indicates the IP address (0.0.0.2) of the PC 100, and the value of the source IP address (IP-S), which is set in the Sender protocol address field, indicates the IP address (0.0.1.2) of the PC 102. The data field of the wake-up packet includes 6 bytes of FF, and 16 duplications of the MAC address of the PC 100.

(5) The router 101 intends to send the wake-up packet, which is received from the PC 102, to the PC 100 with the IP address 0.0.0.2, which is present in the subnet A. However, the router 101 does not recognize the MAC address of the PC 100.

(6) In this case, the router 101 sends to the LAN in the subnet A an ARP request packet for inquiring about the MAC address of the PC 100. This ARP request packet includes the IP address of the PC 100.

(7) Although the PC 100 is in the sleep state, the network controller 118 of the PC 100 is able to reply to the ARP request packet since the ARP request packet including the IP address of the PC 100 agrees with the ARP data that is stored in the data table register 204. The network controller 118 sends transmission data, which is stored in the transmission data register 206, to the LAN as an ARP reply packet. This ARP reply packet includes the MAC address of the PC 100. By receiving the ARP reply packet, the router 101 can recognize the MAC address of the PC 100 even when the PC 100 is in the sleep state.

(8) The router 101 sends the wake-up packet, which is received from the PC 102, to the PC 100. FIG. 13 shows an example of the data structure of this wake-up packet. In the wake-up packet, the value of the Destination address (D) indicates the MAC address (00-00-00-00-00-02) of the PC 100, and the value of the Source address (S) indicates the MAC address (00-00-00-00-00-01) of the router. The value of the source IP address (IP-S) is, for instance, the IP address (0.0.0.1) of the router.

(9) The wake-up packet for waking up the PC 100 agrees with the WOL data that is stored in the data table register 204. Thus, in response to the reception of the wave-up packet, the network controller 118 outputs a wake-up signal. Thereby, the PC 100 is woken up.

As has been described above, in the present embodiment, the network controller 118 can reply to the ARP request packet from the router 101 even while the PC 100 is in the sleep state. Therefore, the wake-up packet, which is sent from the PC 102 in the subnet B and is destinated to the PC 100, can correctly be forwarded to the PC 100 in the subnet A via the router 101, and the PC 100 in the subnet A can be woken up from the PC 102 in the subnet B.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A network controller provided in an information processing apparatus and configured to execute communication with a network, comprising:
a data register configured to store first data indicative of a data pattern of an address resolution protocol request packet comprising a network address of the information processing apparatus, and second data indicative of a data pattern of a wake-up packet for waking up the information processing apparatus;
a transmission data register configured to store transmission data indicative of a data pattern of an address resolution protocol reply packet comprising a physical address of the information processing apparatus;
a comparison unit configured to compare a data pattern of an incoming packet from the network with the first data and the second data while the information processing apparatus is in a sleep state;
a transmission unit configured to send the address resolution protocol reply packet to the network in accordance with the transmission data stored in the transmission data register, if the data pattern of the incoming packet corresponds with the first data; and
a wake-up signal output unit configured to output a wake-up signal for instructing wake-up to the information processing apparatus, if the data pattern of the incoming packet corresponds with the second data.

2. The network controller of claim 1, wherein
the first data is indicative of a data pattern of an address resolution protocol request packet which is sent to the information processing apparatus from a router which is connected to the network, and
the transmission data is indicative of a data pattern of an address resolution protocol reply packet which is to be sent to the router in reply to the address resolution protocol request packet from the router.

3. The network controller of claim 1, further comprising a mask register configured to store mask data which designates a data portion of the first data, which is to be excluded from objects of matching with the incoming packet, wherein the comparison unit is configured to determine whether a data portion of the first data, other than the data portion that is designated by the mask data, corresponds with the data pattern of the incoming packet.

4. The network controller of claim 2, further comprising a mask register configured to store mask data which designates a data portion of the first data, which is to be excluded from objects of matching with the incoming packet,
wherein the comparison unit is configured to determine whether a data portion of the first data, other than the data portion that is designated by the mask data, corresponds with the data pattern of the incoming packet.

5. An information processing apparatus which is configured to execute communication with a network by a network controller, comprising:
a processor configured to execute, before the information processing apparatus transitions into a sleep state, (a) a process of setting first data which is indicative of a data pattern of an address resolution protocol request packet comprising a network address of the information processing apparatus, and second data which is indicative of a data pattern of a wake-up packet for waking up the information processing apparatus, in a data register within the network controller, (b) a process of setting transmission data which is indicative of a data pattern of an address resolution protocol reply packet comprising a physical address of the network controller, in a transmission data register within the network controller, and (c) a process of setting the network controller in a sleep mode in which the network controller is configured to monitor incoming of the wake-up packet;
a comparison unit provided in the network controller and configured to compare a data pattern of an incoming packet from the network with the first data and the second data, while the information processing apparatus is in a sleep state;
a transmission unit within the network controller, the transmission unit configured to send the address resolution protocol reply packet to the network in accordance with the transmission data stored in the transmission data register, if the data pattern of the incoming packet corresponds with the first data; and
a wake-up signal output unit within the network controller and configured to output, if the data pattern of the incoming packet corresponds with the second data, a wake-up signal for instructing wake-up to the information processing apparatus.

6. The information processing apparatus of claim 5, wherein the first data is indicative of a data pattern of an address resolution protocol request packet which is sent to the information processing apparatus from a router which is connected to the network, and
the transmission data is indicative of a data pattern of an address resolution protocol reply packet which is to be sent to the router in reply to the address resolution protocol request packet from the router.

7. The information processing apparatus of claim 5, wherein the processor is configured to further execute a process of setting in a mask register within the network controller, mask data which designates a data portion of the first data to be excluded from objects of matching with the incoming packet, before the information processing apparatus transitions into the sleep state, and
the comparison unit is configured to determine whether a data portion of the first data, other than the data portion that is designated by the mask data, corresponds with the data pattern of the incoming packet.

8. The information processing apparatus of claim 6, wherein the processor is configured to further execute a process of setting in a mask register, within the network controller, mask data which designates a data portion of the first data to be excluded from objects of matching with the incoming packet, before the information processing apparatus transitions into the sleep state, and
the comparison unit is configured to determine whether a data portion of the first data, other than the data portion that is designated by the mask data, corresponds with the data pattern of the incoming packet.

9. A remote wake-up control method for waking up an information processing apparatus, comprising:
executing, before the information processing apparatus transitions into a sleep state, (a) a process of setting first data which is indicative of a data pattern of an address resolution protocol request packet comprising a network address of the information processing apparatus, and second data which is indicative of a data pattern of a wake-up packet for waking up the information processing apparatus, in a data register in a network controller within the information processing apparatus, (b) a process of setting transmission data which is indicative of a data pattern of an address resolution protocol reply packet comprising a physical address of the network controller, in a transmission data register within the network controller, and (c) a process of setting the network controller in a sleep mode in which the network controller is configured to monitor incoming of the wake-up packet;
executing, by the network controller, a comparison process of comparing a data pattern of an incoming packet from a network with the first data and the second data, while the information processing apparatus is in a sleep state;
executing, by the network controller, a process of sending the address resolution protocol reply packet to the network in accordance with the transmission data stored in the transmission data register, if the data pattern of the incoming packet corresponds with the first data; and
executing, by the network controller, a wake-up signal output process of outputting a wake-up signal for instructing wake-up to the information processing apparatus, if the data pattern of the incoming packet corresponds with the second data.

10. The remote wake-up control method of claim 9, wherein the first data is indicative of a data pattern of an address resolution protocol request packet which is sent to the information processing apparatus from a router which is connected to the network, and
the transmission data is indicative of a data pattern of an address resolution protocol reply packet which is to be sent to the router in reply to the address resolution protocol request packet from the router.

11. The remote wake-up control method of claim 9, further comprising
executing a process of setting in a mask register, within the network controller, mask data which designates a data portion of the first data to be excluded from objects of matching with the incoming packet, before the information processing apparatus transitions into the sleep state, and the comparison process comprises a process of determining whether a data portion of the first data, other than the data portion that is designated by the mask data, corresponds with the data pattern of the incoming packet.

12. The remote wake-up control method of claim 10, further comprising:
executing a process of setting in a mask register within the network controller, mask data which designates a data portion of the first data, which is to be excluded from objects of matching with the incoming packet, before the information processing apparatus transitions into the sleep state,
wherein the comparison process comprises a process of determining whether a data portion of the first data, other than the data portion that is designated by the mask data, corresponds with the data pattern of the incoming packet.
